(19) United States
(12) Patent Application Publication
(10) Pub. No.: US 2015/0201428 A1
(43) Pub. Date: Jul. 16, 2015

(54) CQI ADJUSTMENT

(71) Applicant: Vodafone IP Licensing Limited, London (GB)

(72) Inventors: Ashley Mills, London (GB); Eric Douglas Murray, London (GB)

(21) Appl. No.: 14/420,340

(22) PCT Filed: Aug. 8, 2013
(86) PCT No.: PCT/GB2013/052116

§ 371 Date: Feb. 6, 2015

(30) Foreign Application Priority Data
Aug. 8, 2012 (GB) 1214185.9

(51) Int. Cl. H04W 72/12

(52) U.S. Cl. CPC H04W 72/1231

(57) ABSTRACT

A base station of a cellular telecommunications network is provided, the base station being adapted to: receive a channel quality indicator ‘CQI’ from a user equipment ‘UE’; determine an indication of radio conditions at a first time contributing to the received CQI; and, schedule actions or instructions, including selecting a modulation and coding scheme ‘MCS’, in accordance with an adjusted CQI, wherein the adjusted CQI is calculated by: determining an indication of radio conditions at a second time later than the first time; and, evaluating the indication of radio conditions at the second time against the indication of radio conditions contributing to the received CQI. A method and computer readable storage medium are also provided.

### CROSS-REFERENCE TO RELATED APPLICATIONS

This application is a national stage application under 35 U.S.C. §371 of International Application No. PCT/GB2013/052116 entitled “CQI ADJUSTMENT” filed Aug. 8, 2013, which claims priority to Great Britain Patent Application No. 1214185.9 entitled “CQI ADJUSTMENT” filed Aug. 8, 2012, the disclosure of both applications is hereby expressly incorporated by reference herein in its entirety.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the implementations.

The various illustrative blocks, modules, and circuits described in connection with the implementations disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the implementations disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk, and blu ray disc where disks usually reproduce data magnetically, while discs reproduce data optically with lasers. Combinations of the above should also be included within the scope of computer readable media. The processor and the storage medium may reside in an ASIC. The ASIC may reside in a user terminal. In the alternative, the processor and the storage medium may reside as discrete components in a user terminal.

### BACKGROUND TO THE INVENTION

In mobile telecommunications networks, communications between mobile devices and the access portion of the network are sent in transmission slots, or time slots. Typically, a scheduler is responsible for allocating these transmission slots to a number of different mobile devices communicating with the network in both the downlink (DL) and uplink (UL) directions.

In addition to allocating transmission slots to devices, i.e. choosing when transmissions will occur, the scheduler also decides the modulation and coding scheme (MCS) that is to be used for each transmission and instructs the mobile devices accordingly. An MCS is a particular modulation used for communications at the physical layer.

The MCS allocated to a mobile device determines how data being sent to the mobile device is to be encoded. Different MCS schemes exist which offer different degrees of error correction and data redundancy. A low order MCS offers a high degree of redundancy but sacrifices bit rate when compared to a higher order MCS which offers less protection against errors but increases the bit rate and improves throughput. It is typical to use a low order MCS in poor radio conditions and to use a higher order MCS when radio conditions are good. By matching the MCS to the current radio conditions, a more efficient use of the radio channel can be achieved.

In order to decide which MCS to use for a given transmission and for a given device, the scheduler uses channel quality index (CQI) reports which have been sent from the device and which indicate the state of the radio channel. The CQI is a recommendation from the device about which MCS the scheduler should allocate to that device, based on the latter's estimate of current radio conditions. Device CQI reports can be wideband, in which case the value represents an average of the radio conditions over all sub-bands, or they can be narrowband; that is, specific to a particular sub-band.

Examples of the CQI reports sent by the devices are outlined in the 3GPP TS 36.213 specification V9.3.0, which is incorporated herein by reference. Specifically, Table 7.2.3-1 outlines various characteristics of the CQI.

One problem in the use of CQI data is that the radio conditions at the time at which it is measured may be significantly different from the time at which it is used. This is illustrated in FIG. 1. At time point t−n, the device sends one or more CQI reports to the network. After some varying amount of time, depending on scheduling strategy and other network configurations, at time t the scheduler makes use of the received CQI report. For DL transmission, at time t, scheduling actions will be executed, whereby an MCS and set of resource blocks will be chosen for the device and data sent to that device. As described above, the network will use the received CQI report to allocate an MCS. In the UL direction, scheduling instructions will be sent to inform the device with which MCS, upon which resource blocks, and at what time, it should transmit. Again, the network uses the CQI report, at time t, in order to determine the MCS.

In either case, if the CQI at the point of report is significantly different from the value it would be if recalculated at the point at which it is used, then the MCS choice may be rendered sub-optimal. This may result in either increased or reduced likelihood of the transmitted block being received in error. Both occurrences are undesirable, since in the former case the rate of errors will be higher, resulting in lower cell throughputs, and in the latter case, the cell will be under-utilised, again resulting in lower cell throughput.

The differences between the CQI at the point of measurement and the “real” CQI at the point of use arise because the network is dynamic and conditions change continually. Some of this difference can be attributed to natural evolution of the radio channel, as the receiver Signal to Interference plus Noise Ratio (SINR) waxes and wanes in accordance with shadowing and fast fading variations. There are of course other factors which may contribute to changing the conditions contributing to the CQI at any point in time.

In theory these changes in radio conditions could be predicted using a dynamic regression method such as a Kalman filter. However, in practice, at useful timescales these changes generally emulate random processes and are thus somewhat intractable. An example of such a prediction method is disclosed in U.S. Pat. No. 7,912,490.

The present invention seeks to provide an improvement in resource scheduling and MCS allocation that addresses the above drawbacks caused by changes in radio conditions between the time of receiving a CQI report and the time of using the CQI report for the purpose of scheduling.

### SUMMARY OF THE INVENTION

According to a first aspect of the present invention, there is provided a base station of a cellular telecommunications network, the base station being adapted to: receive a channel quality indicator ‘CQI’ from a user equipment ‘UE’; determine an indication of radio conditions at a first time contributing to the received CQI; and, schedule actions or instructions, including selecting a modulation and coding scheme ‘MCS’, in accordance with an adjusted CQI, wherein the adjusted CQI is calculated by: determining an indication of radio conditions, the radio conditions at a second time later than the first time; and, evaluating the indication of radio conditions at the second time against the indication of radio conditions contributing to the received CQI. The second time may be the time of scheduling or alternatively, the second time may be the time the actions or instructions are scheduled to occur.

As is described herein, knowledge of the historical scheduling behaviour of neighbouring cells and knowledge of their future scheduling behaviour may be used to improve the accuracy of CQI reports. The present invention results in lower error rates and a consequential increase in cell throughputs. The advantages of the present invention are provided without thought of total interference prediction. The present invention does not concern itself with second guessing the influence of essentially random processes, but rather is focused on keeping track of known determinants of CQI and correcting for variance between the point of their measurement and their use. Preferably, the present invention allows the adjustment of the received CQI based, for example, on (i) measurements made in the network at a time after the CQI was originally computed by the UE and/or (ii) information about network conditions occurring at a time after the CQI was originally computed by the UE and/or (iii) indications derived from said measurements and/or said information.

Although the present invention is described as being carried out in a base station, it will be understood that the invention may be carried out by any infrastructure suitably adapted. For example, a distributed system of components may be suitably configured. Equally, the infrastructure does not need to be co-located with a transmitter or with other radio access network components.

The determination of an indication of radio conditions contributing to the received CQI may include monitoring the transmission state of neighbouring cells of the cellular telecommunications network. The monitored cells may or may not be the nearest neighbour cells, i.e. adjacent cells, but will preferably be any neighbouring cells that may affect the interference component of the CQI measurement. In this way, an accurate picture of the interference component of the CQI can be established by the base station. Further, the base station may be adapted to store a CQI associated with each transmission state of neighbouring cells of the cellular telecommunications network. The CQIs are stored for subsequent use.

Additionally, the base station may be further adapted to maintain historical information regarding the transmission state of neighbouring cells of the cellular telecommunications network at particular time intervals. The adjusted CQI may be an average CQI, the average CQI reflecting the proportional occurrence of each transmission state in the historical information and calculated using the stored CQI associated with each transmission state. This reflects that the CQI itself may be a historical average of conditions encountered by the UE. The base station may be further adapted to update the stored CQI associated with each transmission state, only if the transmission state occurred over the entire period for which the CQI was calculated.

Additionally, the base station may be further adapted to: request that a CQI be calculated and transmitted by the UE; cause a particular behaviour to occur in neighbouring cells while the UE is calculating the CQI; and, store the CQI in association with the caused behaviour. Thus, the base station may be able to estimate how a CQI will vary based on interference caused by neighbouring cells.

The determination of an indication of radio conditions contributing to the received CQI may include: receiving a reference signal from each of the neighbouring cells indicative of downlink path loss at the UE. The received reference signal may be weighted according to the power transmitted by the cell from which the reference signal originates. The determination may further include averaging the received CQI and the received reference signals. By basing the adjustment on the path loss of the transmission, the accuracy of the CQI adjustment can be increased because further interference caused by factors in addition to the neighbouring cells can be accounted for.

Additionally, the base station may be adapted to: maintain a running average of CQI values for each weighted Reference Signal Received Power ‘RSRP’ value and for each part of a frequency band irrespective of the UE from which the values were obtained, thus normalising the stored values.

The evaluation may also include: computing a reference signal, indicative of downlink path loss at the UE, that will apply for the UE at the second time; determining a first expected CQI corresponding to the stored CQI associated with the computed reference signal in the store; determining a second expected CQI corresponding to the stored CQI associated with the received reference signal in the store; calculating the difference between the first and second expected CQIs to form an adjustment parameter; and, applying the adjustment parameter to the received CQI to form the adjusted CQI. In this way, the accuracy of the CQI adjustment is improved.

According to a second aspect of the present invention, there is provided a method in a cellular telecommunications network, the method comprising: receiving a channel quality indicator ‘CQI’ from a user equipment ‘UE’; determining an indication of radio conditions at a first time contributing to the received CQI; and, scheduling actions or instructions, including selecting a modulation and coding scheme ‘MCS’, in accordance with an adjusted CQI, wherein the adjusted CQI is calculated by: determining an indication of radio conditions, the radio conditions at a second time later than the first time; and, evaluating the indication of radio conditions at the second time against the indication of radio conditions contributing to the received CQI. The present invention also includes apparatus suitable for carrying out the method steps. According to a third aspect of the present invention, there is provided a computer-readable storage medium having stored thereon instructions which can be executed to perform the above method.

### BRIEF DESCRIPTION OF THE DRAWINGS

An example of the present invention will now be described in detail with reference to the accompanying drawings, in which:

FIG. 1 shows the use of CQI reports over time;

FIG. 2 shows a schematic illustration of user equipment and resource usage of three co-sited cells at a time t−n;

FIG. 3 shows a schematic illustration of user equipment and resource usage of three co-sited cells at a later time t;

FIG. 4 shows a flow diagram illustrating a first exemplary implementation of the present invention;

FIG. 5 shows a schematic illustration of three user equipments in one sector and three co-sited cells;

FIG. 6 shows a flow diagram illustrating a further exemplary implementation of the present invention; and,

FIG. 7 shows a contour plot indicating weighted RSRP values for two sectors.

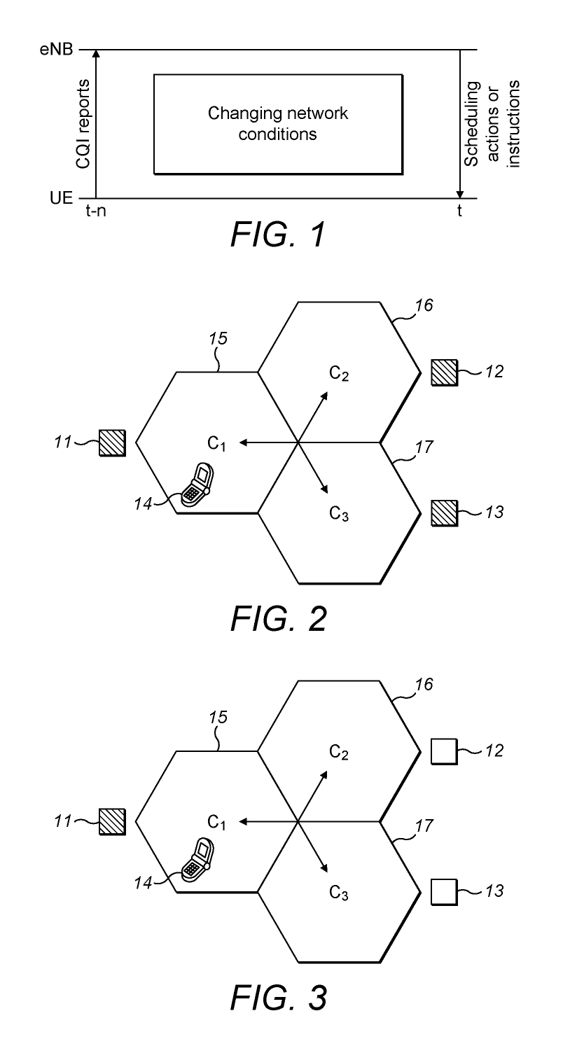

### DETAILED DESCRIPTION

In the following description, reference will be made to Global System for Mobile Communications (GSM), Universal Mobile Telecommunications System (UMTS), Long Term Evolution (LTE) and to particular standards. However it should be understood that the present disclosure is not intended to be limited to these. The present invention may also be applicable to a number of modes of transmission such as Time Division Duplex (TDD), Frequency Division Duplex, Time Divisions-Synchronous Code Division Multiple Access (TD-SCDMA), and High Speed Downlink Packet Access (HSDPA), among others.

While devices are often referred to as “mobile” in the description herein, the term “mobile” should not be construed to require that a device always be mobile, merely that it has the capability of being in communication with a wireless telecommunications network which allows mobility. For instance, a PC terminal or a machine to machine client that is never moved from a particular geographic location may in a sense still be considered mobile as it could be moved to a different location yet still access the same network. Where the term “mobile device” is used in the present discussion it is to be read as including the possibility of a device that is “semi-permanent” or even “fixed” where the context does not contradict such an interpretation.

Although throughout the following description the present invention is described in the context of an LTE network, it will be understood that the principles are equally applicable to other wireless data telecommunications networks such as UMTS, WIMAX, cdmaOne and its variants. Each specification and standard may define equivalent terms to those used herein such as Channel Quality Index (CQI) and Reference Signal Received Power (RSRP). For convenience, only the LTE specific terms are used throughout.

In a typical cellular radio system, a wireless telecommunications device communicates via one or more radio access networks (RAN) to one or more core networks. The RAN includes a plurality of base stations (BS), each base station (BS) corresponding to a respective cell of the telecommunications network. The mobile devices may be handheld mobile telephones, personal digital assistants (PDAs), smartphones, tablet computers or laptop computers equipped with a data card among others. In a UMTS or LTE system, such devices are typically referred to as User Equipment (UE). In a GSM system, such devices are typically referred to as Mobile Stations (MS). In the description herein both terms may be used interchangeably, however it will be noted that the term UE will be used predominantly.

LTE (Long Term Evolution) is a next generation network technology created by the 3rd Generation Partnership Project (3GPP). It has been designed to deliver high data throughput to mobile users. In LTE a scheduler is situated at the base station, i.e. the evolved-Node B (eNB), and is responsible for allocating transmission slots in the downlink (DL) and uplink (UL) directions to and from UEs. Throughout the description, the terms base station and eNB may be used interchangeably.

Typically, a UE will make a channel quality index (CQI) measurement for subsequent transmission to the eNB. CQI is an index and does not have a particular unit. Upon receipt of the CQI from the UE, the eNB may use the value to set the transmission parameters for data transmission between the UE and the eNB. The measurements performed by the UE may be performed on any DL channel either individually, or in combination with another channel.

When the CQI measurement is made by the UE, the neighbouring cells may be contributing to the interference component of that estimate. Typically, the transmission or reception by a neighbouring cell of data will cause interference and affect the interference component of the CQI estimate. If the cells are not using their resources, that is, transmitting or receiving data over a set of sub-bands, the resources may not be contributing to the interference component of the CQI estimate. The term resource is used in the present description to describe a particular frequency or sub-band, or alternatively the entire wideband. The nature of the resource is not important in the present description, merely that use of the resource by neighbouring cells contributes to the interference component of the CQI measurement.

FIG. 2 illustrates the generalised principle described above, in which the resources used by the cell affect the interference component of the CQI measurement performed by the device. For the sake of example, communication among cells at a single site is described. It is clear, however, that the techniques described herein are equally applicable to any set of cells that can communicate with each other. The cells need not be co-sited. A geographical area may be divided into a plurality of sectors, each served by a particular cell and corresponding base station. A co-sited set of cells and their respective sectors is shown schematically in FIG. 2. Three cells are depicted C₁, C₂ and C₃, each covering geographical sectors: 15, 16, and 17, respectively.

FIG. 2 shows the use of resources in three sectors 15, 16 and 17, at the time of CQI measurement, t−n. A UE 14 is positioned within the geographical area and is being served by one of the cells, C₁ in sector 15. The blocks to the side of each cell 11, 12 and 13 represent a particular resource, which could be a sub-band or the entire wideband resource. In this and the other illustrations, when the block is filled in with hatching it is in use and when it is coloured white it is not in use.

In the example of FIG. 2, the same resource is in use in all three cells 15, 16, 17. The nature of the resource is not important in the present examples. The depicted resource use indicators 11, 12 and 13 merely indicate that interference is being generated which affects the interference component of the CQI measurement.

In this example, let a first cell C₁, covering sector 15, be the focus cell. Cell C₁ receives a CQI report from the UE 14 which is in its serving area. The interference caused by cells C₂, covering neighbouring sector 16, and C₃, covering neighbouring sector 17, will have an impact on the CQI value reported by the UE 14 at the time the CQI is measured, which we will refer to as t−n.

As described above, the MCS is selected by the scheduler, which is part of the base station, in order to effectively utilise the available transmission capacity and account for errors in the transmission. The CQI measurement report is used by the scheduler to choose the most effective MCS for the conditions of the UE.

FIG. 3 shows the intended use of resources at the point of scheduling, i.e. the CQI use point, t. The figure illustrates the intended use of a resource by each cell at the time of CQI use. In this case, the second and third cells, C₂ and C₃, respectively, will not be using the resource at the time the CQI is used. C₁ on the other hand intends to use the resource, i.e. transmit on that particular sub-band.

At the point of CQI measurement, t−n, it was the case that the second and third cells C₂ and C₃, covering sectors 16 and 17, respectively, were transmitting data and thus contributing to the interference experienced by the first cell C₁. The cells were thus also contributing to the interference component of the CQI measurement made by the cell.

However, when the first cell C₁ transmits at time t, it will not receive the same interference from the other cells C₂ and C₃ because, as shown in FIG. 3, they are not using the particular resource we are considering. Thus, the reported CQI measurement is likely to underestimate the actual CQI at this time, since the radio conditions are now improved. A higher CQI indicates better radio conditions than a lower CQI.

In summary, the more appropriate CQI value may be different from the CQI value measured by the UE at an earlier time, since the interference conditions may have changed. The interference may be caused by radio conditions, such as the use of a particular resource by neighbouring cells, or other factors. As mentioned above, the difference between the more appropriate CQI and the measured CQI can cause sub-optimal cell throughput and high error rates.

An aim of the present invention is to reduce the difference between the more appropriate CQI and the measured CQI used by the base station when allocating an MCS. In accordance with an embodiment, the relative resource usage at the points of measurement and use is taken into consideration when allocating the MCS. In order to determine this, the base stations may be operative to share information regarding their transmission states at particular time intervals either in real time, in advance, or after the fact.

If there was less interference at the point of measurement than there is at the point of schedule, the measured CQI is likely to be an over-estimate of the more appropriate CQI, and should be decreased by a certain value. If there was more interference at the point of measurement than there is at the point of scheduling, then the measured CQI is likely to be an under-estimate of the more appropriate CQI, and should be increased by a value.

In accordance with an embodiment of the present invention, the measured CQI value may be adjusted, when used by the scheduler, using the last CQI measurement, the radio conditions at the time of measurement, and knowledge of the intended resource usage at interfering cells. A number of exemplary implementations of this principle will now be described.

In a first exemplary embodiment, the eNB may keep track of the CQI measurement for each sub-band k, for each possible state of the neighbouring cells or more generally for any communicating set of cells. In effect, the cells using the sub-band resource can be considered to be contributing to the radio conditions at the time. As stated above, the neighbouring cells may inform the eNB of their transmission states for the eNB to use in this determination.

For the example of a single site, and considering one sector alone, the following states can exist:
(A) Neither neighbour is using sub-band k;
(B) Neighbour C₂ is using sub-band k;
(C) Neighbour C₃ is using sub-band k; and,
(D) Both neighbours are using sub-band k.

The base station, eNB, may be operative to record the CQI measurements for each state and generate a mean CQI for that state, such that the mean differences in CQI for the different states can be estimated. Using these estimates, a CQI measurement made when the system was in state A, for example, can be adjusted into one which is valid for a system that is now in state C. In one example, the eNB is operative to reduce, or increase, the CQI measurement by the mean difference between the state at which the CQI was measured and the state at which is was received.

For the sake of example, imagine that each state s in A to D above converges to the following average CQI values mCQI(s):
mCQI(A)=9
mCQI(B)=7
mCQI(C)=5
mCQI(D)=4

Note that since CQI is an index, it does not have a unit. The concept of the CQI is that a higher index is a recommendation to use a higher order MCS. The scheduler uses this CQI in order to allocate an MCS. The specific index values are set out in the 3GPP TS 36.213 specification.

If the eNB at the first cell C, was in state A when the CQI measurement was received from the UE 14, but is in state D when it comes to scheduling, then the eNB can estimate that the measured CQI is greater than the actual CQI and decide to reduce the measured CQI by some value to form a compensated CQI value. In one embodiment, this value may be the mean difference between the CQI values recorded when the UE is in each state.

In another example, the eNB at the first cell C₁ was in state C when the CQI measurement was received by UE, but is in state A when the CQI is to be used. The eNB can then assume that the actual CQI value will be higher than the measured CQI value, and should therefore increase the measured CQI by a value to form a compensated, or adjusted, CQI value. Again, in one embodiment, this value may be the mean difference between the CQI values recorded when the UE is in each state.

It is contemplated that the CQI may be adjusted, not only for when the CQI is used by the scheduler, i.e. accounting for radio conditions at the time of scheduling, but also predictively, that is, accounting for radio conditions at the time of subsequent data transmission. In all the examples given herein, where it is stated that the radio conditions are considered at the time of scheduling, the base station may also be operative to consider future radio conditions, either through communications between the neighbouring cells of their intended resource usage or through sophisticated prediction algorithms. For convenience, the following description will predominantly refer to the conditions at the time of use, or scheduling.

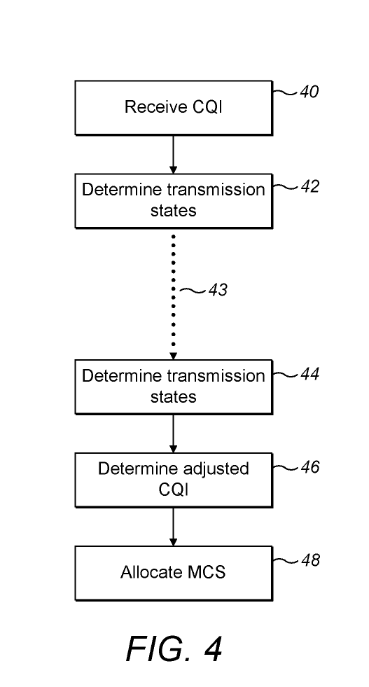

FIG. 4 is a flow diagram showing the present example. At step 40, the base station receives a CQI from the UE. The base station, through communications with the neighbouring cells, is operative to determine the transmission states of the neighbouring cells at the time the CQI was measured, step 42. After some time, indicated by broken line 43, the base station is operative to determine the transmission states, either at the time of scheduling or predictively, as described above. The base station is then operative to use this determination to determine an adjusted CQI, step 46 and subsequently utilise the adjusted CQI to allocate an MCS for data transmission to or from the UE.

In a further exemplary implantation, the eNB may be operative to maintain CQI averages for each state-UE pair, that is, a CQI average is maintained specific to each UE and not a generic mean CQI for each state irrespective of the UE on which the CQI was measured. In this way, a more accurate adjustment can be made. The example described above can be considered to be a CQI average for a generic UE, whereas this example, can be considered to be specific to the UE in question.

Once the CQI averages are maintained for each state-UE pair, the stored CQI averages may optionally then only be used when providing scheduling for that UE. Alternatively, the CQI value for that UE may be used by the eNB in preference to an average CQI value for all UEs when such a maintained CQI value is available. Such a precedence scheme may also apply to any of the examples described herein as will become clear from the discussion below.

In this specific embodiment, where the eNB maintains averages per UE, assuming two UEs x, and y, the eNB can compute and store (where mCQI(S,u) is the mean CQI in state S for u, using only the measurements reported by the UE):
mCQI(A,x) mCQI(A,y)
mCQI(B,x) mCQI(B,y)
mCQI(C,x) mCQI(C,y)
mCQI(D,x) mCQI(D,y)

For a given cell state S, the mean CQI may potentially differ significantly among different UEs. Thus, using a mean CQI for the target state obtained only from the CQI reports of the UE being scheduled may produce better results than using a mean CQI for the target state obtained as an amalgam of all UE CQI reports. Therefore, as stated above, in one embodiment, the CQI value for a specific UE may be used by the eNB in preference to an average CQI value for all UEs when such a maintained CQI value is available.

In a further embodiment, the measured CQI may be adjusted when used by the base station based on a history of recorded CQI measurements. Expanding on the principles described in the above embodiments, an adjusted CQI value may be calculated using more than just the instantaneous state at the point of CQI measurement. It is noted that the CQI reports at the UE usually undergo some kind of historical averaging by the UE and, as such, the CQI at the point of measurement cannot readily be said to be precisely one of the states A to D but it rather represents measurements made over a sequence of states A to D over time. Typically, the CQI may be a rolling average such as an exponentially decaying average or a weighted average.

In this embodiment, the base station, eNB, maintains historical information about the transmission states of neighbouring cells, i.e. the radio conditions, in order to improve the accuracy of the CQI at the point of use. The eNB may then be operative to correct the CQI when it is subsequently used. This CQI correction can be considered as an average, corrected to reflect the proportional occurrence of each of the states A to D in the measurement history.

Consider the resource usage history on sub-band k for two neighbouring cells C₂ and C₃ over a previous n transmission time intervals (TTIs). For the sake of example, let n=5, and let Sₖ represent the state of the resource k in the following manner, where the two columns represent the states of cells C₂ and C₃ respectively and 1 represents that the resource is in use, and 0 represents that the resource is not in use:

$${S}_{k} = [ \begin{matrix}11 \\ 10 \\ 01 \\ 00 \\ 11\end{matrix} ] \begin{matrix}t - 1 \\ t - 2 \\ t - 3 \\ t - 4 \\ t - 5\end{matrix}$$

The historical data is actually a composite of states A to D, described above, and could be written as:

$${S}_{k} = [ \begin{matrix}D \\ B \\ C \\ A \\ D\end{matrix} ] \begin{matrix}t - 1 \\ t - 2 \\ t - 3 \\ t - 4 \\ t - 5\end{matrix}$$

The eNB may be operative to estimate the transmission states of the neighbouring cells when the data is to be transmitted, preferably using information shared by neighbouring cells.

In the situation where a state P is the CQI which would otherwise be used for scheduling at time t, i.e the normal CQI, the CQI correction at time t can be estimated as follows:

$$CQICorrection ( t ) = \frac{2}{5} \cdot ( mCQI ( P ) - mCQI ( D ) ) + \frac{1}{5} \cdot ( mCQI ( P ) - mCQI ( B ) ) + \frac{1}{5} \cdot ( mCQI ( P ) - mCQI ( C ) ) + \frac{1}{5} \cdot ( mCQI ( P ) - mCQI ( A ) )$$

That is, the CQI adjustment can be considered as an average corrected to reflect the proportional occurrence of each of the states A-D in the measurement history.

It was described above that the CQI report sent from the UE to the eNB may be derived from historical averaging across a mixture of states. Thus, the eNB may need to determine or estimate the CQI corresponding to each “pure” transmission state in order to perform the correction calculation described above since the correction calculation performs an average of the recorded states. A “pure” state, such as mCQI(A), mCQI(B) etc., is considered to be a state, which for every time-step, the same state occurs.

In a first example, the eNB monitors the state history for time t−5 to t−1 and whenever a “pure” state occurs, then the mean for that state is updated. Alternatively, the eNB may be operative to deliberately cause the desired neighbour behaviour during a calibration phase or the values for states A to D, i.e. the “pure” states, could be computed a priori offline using radio propagation prediction tools and simulated transmissions, given the known positions and environments of the basestations.

In a further embodiment, mean CQIs may be generated and stored for each time point and for each state at that time point in order to create what will be referred to as a ‘unique’ state. In the case of a measurement history of length n=5, and considering the four possible ‘unique’ transmission states of the intrasite neighbours, this would give 4⁵ possible transmission states. At each time point, a unique state is defined by the transmission history of the focus cell and its immediate neighbours. If mean CQI data is stored for each unique state, then the CQI correction can be computed based on the difference between the state at point of CQI measurement and the state at the point of CQI use.

It is worth noting that the technique described above can be extended to more than two neighbours by increasing the size of the state space. The invention is not limited to any particular number of, or values of, states or time steps. Four states and five time steps have been used in the present examples for illustrative purposes only.

In the above embodiments, a method of adjusting the CQI based on the CQI reports from UEs was presented. This has the benefit of not placing any additional signalling load on the air interface. Additionally, the above examples extol the benefits of sharing information between transmission sites, thus the CQI values can be improved by the sharing of transmission states over time. However, the above embodiments may not account for the specific interference scenario in which a UE may find itself.

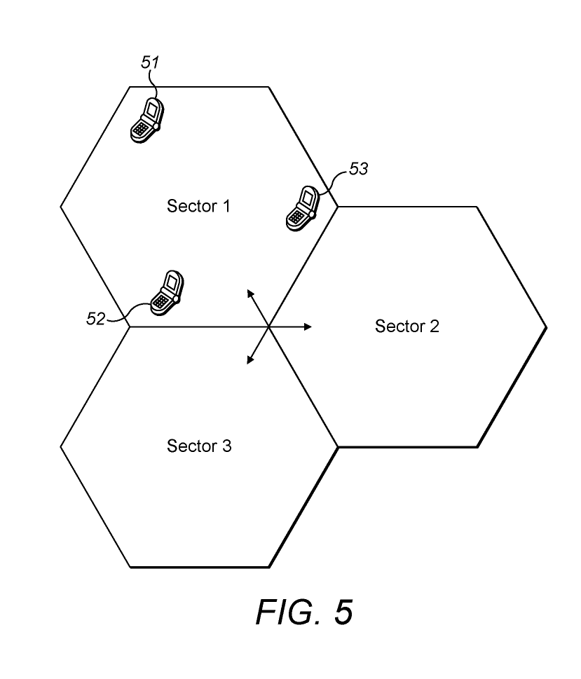

In a further embodiment of the present invention, an adjusted CQI value may be calculated based on the specific radio conditions at the time of scheduling. FIG. 5 illustrates an example of a scenario in the context of which this embodiment will be described. The base stations may be co-located or non co-located as in the previous examples. In this embodiment, a weighting may be applied to the stored CQIs based on the location of the cells in relation to the UE.

In FIG. 5, three UEs are illustrated, all of which are affiliated to Sector 1. These UEs are labelled UE 51, which is located at the far edge of Sector 1; UE 52, which is located near the boundary of Sectors 1 and 3; and UE 53, which is located at the boundary of Sectors 1 and 2.

Since the angle between UE 51 and both Sectors 2 and 3 is such that this UE 51 is located outside of the main beams of both these sectors, it is unlikely that any interference from these sectors will have a significant impact on the CQI reports from UE 51 when compared to the effect of other intersite interference. Hence little, if any, adjustment in the CQI value is required in this case.

If we consider UE 53, however, we can see that this UE 53 is much closer to the main beam of Sector 2, and hence its CQI reports will be more affected by interference from that sector than UE 51. However, UE 53 is still well isolated from interference from Sector 3. Similarly, UE 52 would receive significant interference from Sector 3, but little from Sector 2.

Hence, it can be seen that it would be beneficial to consider an additional CQI adjustment mechanism that would take into account the specific interference scenario experienced by a given UE. The interference received by a given UE from a given eNB is dependent both on the transmission power of the eNB and the path loss between the eNB and the UE. For co-sited sectors as shown in FIG. 5, it is reasonable to assume that the eNB for Sector 1 can know the transmission power for each symbol transmitted by the adjacent sectors, but it cannot autonomously estimate the path loss between them and the UE.

Each eNB, in each cell, transmits detectable symbols, known as reference signals, with a known transmission power. The received power on these reference signals is a standard measurement made by the UE, known as the Reference Signal Received Power, or RSRP, and is signalled to the affiliated eNB. Given RSRP measurements from the UE, the eNB can estimate the contribution of the neighbouring sectors to the interference being received by the UE. It is assumed that at least one RSRP report per sector is received from the UE along with the CQI reports. This may be as part of the normal reporting cycle of the UE, or because these reports were specifically requested by the eNB.

The RSRP signals can be used to estimate path loss and hence the distance of the UE from each cell. Any indication of the distance of the UE from each cell can be used to weight the CQI values and provide an adjusted CQI value that compensates for the specific radio conditions at the time of scheduling. The RSRP signals need not be used in the calculation and are given merely as an example of a signal that can be used for this purpose.

Since the eNB does not know the total interference being received by the UE nor, indeed, the mechanism by which the CQI is computed by the UE, it cannot directly adjust the CQI for the known intrasector interference contribution. To overcome these issues, an algorithm is proposed and is described below.

First, for each CQI report received by the eNB, an associated RSRP value is also received for each of the adjacent sectors (Sectors 2 and 3 in FIG. 4). When multiple (narrowband) CQI reports are received at the same time by the eNB, the same RSRP values will apply to each of these.

Next, the RSRP values must be weighted by the normalised average transmission power that the associated eNB was transmitting during the period over which the CQI was being calculated by the UE, and in the resources that were being considered by the UE when calculating that CQI. This transmission power is then normalised relative to the transmission power used in the reference signals, and hence will normally be a number between 0 and 1. Although it is possible that the eNB may transmit with a higher power that the reference signals for some resources, and hence the number could be higher than unity.

For example, if the reference signal transmit power was 20 dBm, and the adjacent sector was transmitting with an average of 10 dBm in each of the symbols that occupied resources used by the UE to compute the CQI, then the weighting factor would be −10 dB, i.e. 0.1. This average of 10 dBm could arise either because the eNB was transmitting with 10 dBm in all symbols, or with 20 dBm in 10% of the symbols and no power in the remainder, or some other intermediate combination.

The RSRP value is normally expressed as a value in dB, in which case the weighting factor would be applied as a dB offset (a 10 dB reduction for the example above).

For each CQI value, the algorithm will now have two associated weighted RSRP values, that is, one for each of the adjacent sectors. If necessary, perhaps for reasons of accuracy improvement or a reduction in the amount of data to be processed, a number of successive CQI and RSRP values could be averaged to produce a composite data set, consisting of an averaged CQI value and two averaged RSRP values. Various averaging mechanisms can be envisaged; for example, a linear average over a set, a moving average over a fixed period of time or an alpha tracker.

The associated CQI value is recorded in a two-dimensional grid indexed by the weighted RSRP values (in dB). These indices will be quantised to a reasonable resolution (such as 1 dB) and have a reasonable upper and lower limit. A separate grid may be maintained for each narrowband CQI corresponding to a different part of the frequency band. The grid may maintain a running average of the CQI being recorded in each ‘bin’, and hence the individual CQI values need not be stored. Over time, this grid will be populated by CQI values from all UEs, and will provide the eNB with an expectation of the CQI value that should be reported by a UE for a given weighted RSRP index pair.

When the eNB comes to make a scheduling decision based on a CQI report from a UE, it is operative to adjust for the current interference scenario as described below.

The eNB may compute the weighted RSRP values that will apply for the UE during the sub-frame to which the scheduling decision applies. In this case, the weighting factors are computed using the transmission powers that the adjacent sectors will be using in the resources to which the CQI is applicable. As the sectors may be co-sited, this information is assumed to be known to the eNB.

From the two-dimensional grid described above, the eNB obtains the expected CQI value that should be applicable for the weighted RSRP values that have just been calculated. The eNB may also obtain the expected value of the CQI that would be applicable for the RSRP values that were received with the CQI that it wants to adjust before using it for scheduling purposes.

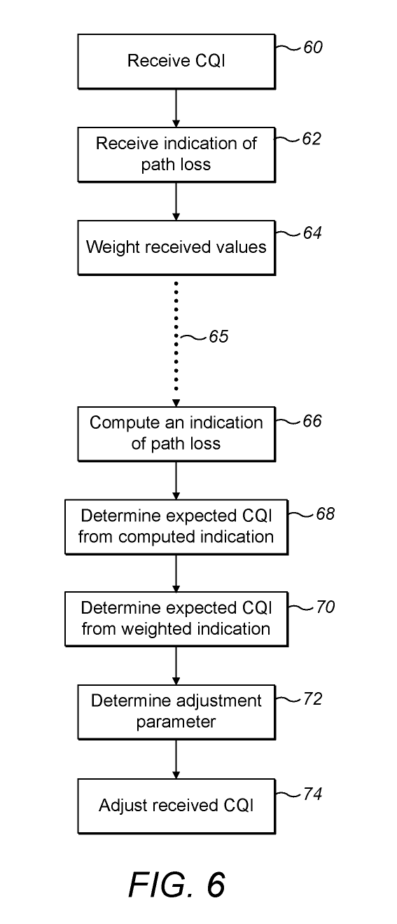

FIG. 6 is a flow diagram showing this example. At step 60, the base station receives a CQI from the UE. The base station also receives an indication of the path loss, shown at step 62. In this example, the indication is the RSRP. The base station, at step 64, is then operative to apply a weighting to the RSRP value. After a subsequent period of time, indicated by broken line 65, the base station is then operative to compute an indication of path loss, either at the time of scheduling or predictively, step 66. The base station is then operative to, at steps 68 and 70, determine an expected CQI from the computed indication and an expected CQI from the weighted indication. The ordering of these steps is of course merely exemplary. Using these values, the base station is then operative to, at step 72, determine an adjustment parameter and subsequently utilise this adjustment parameter to adjust the received CQI for use, step 74.

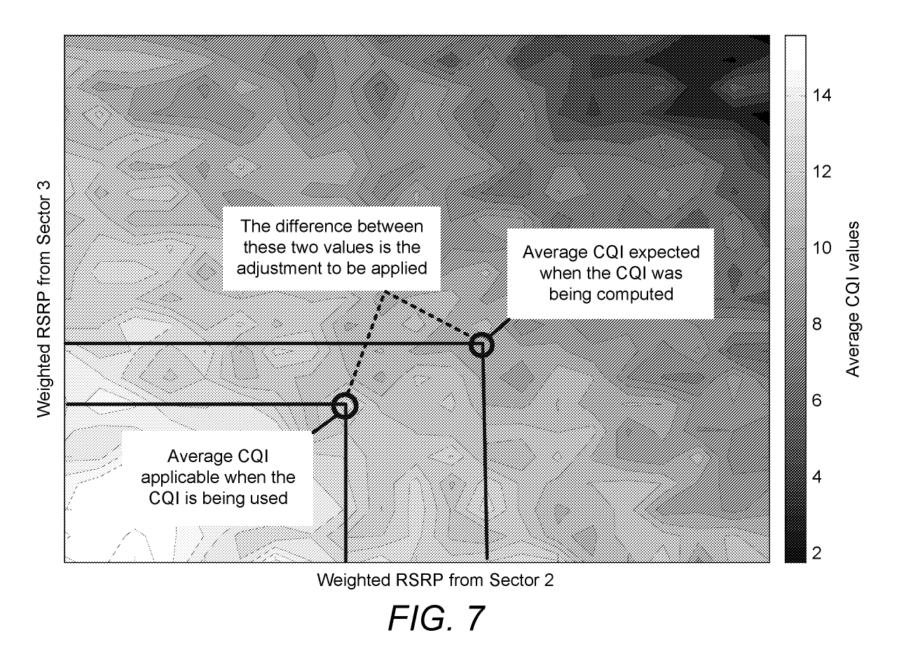

FIG. 7 shows diagrammatically, in a contour plot, the two steps described above. The difference between the two expected CQI values is the adjustment that should be applied to the current CQI value.

For example, say that a CQI value of 10 is received by the eNB with associated weighted RSRP values of 10 dBm for Sector 2 and 15 dBm for Sector 3. Let us also say that the expected CQI value for weighted RSRP values of 10 dBm and 15 dBm is 12.

For the particular sub-frame for which the UE is being scheduled, let us say that the adjacent sectors are lightly loaded, and hence lower weighted RSRP values are expected to apply at the UE for that sub-frame. For example, the values may be 5 dBm and 0 dBm. This lower level of interference suggests that the CQI can be adjusted upwards, to a less robust MCS, since it was estimated when a higher level of interference applied.

For example, if the expected CQI value for weighted RSRP values of 5 dBm and 0 dBm is 14, then the current CQI value should be adjusted upwards by 2 (i.e. 14-12), and hence a value of 12 should apply. Hence, in this case, a higher MCS could be applied than would be suggested by the original CQI report, and the throughput should be greater than would otherwise have been achieved. In other cases, the CQI would be revised down, and a more robust MCS would be used. However, this reflects the higher interference that is expected at the UE compared to the interference environment applicable when the CQI was estimated, and hence this use of a more robust MCS is appropriate.

Instead of RSRP, signals transmitted to and from the UE and Base Station during cell selection, re-selection and handover may be used. The signals are used to provide an indication of radio conditions, i.e. distance from the Base Station and path loss. The CQI values can then be adjusted.

The exemplary embodiments described herein may be used in combination or in isolation. For example, if reference signals are available, the described embodiment in which estimated path loss is used to adjust the CQI may be used in preference to the described embodiment utlising the transmission states of the neighbouring cells, or vice versa. Of course, the embodiments could be used in combination to provide the adjusted CQI.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the implementations.

The various illustrative blocks, modules, and circuits described in connection with the implementations disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the implementations disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk, and blu ray disc where disks usually reproduce data magnetically, while discs reproduce data optically with lasers. Combinations of the above should also be included within the scope of computer readable media. The processor and the storage medium may reside in an ASIC. The ASIC may reside in a user terminal. In the alternative, the processor and the storage medium may reside as discrete components in a user terminal.

1. A base station of a cellular telecommunications network, comprising:
a receiver configured to receive a channel quality indicator (CQI) from a user equipment (UE);
a processor configured to:
determine an indication of radio conditions at a first time contributing to the received CQI, and
schedule actions or instructions, including selecting a modulation and coding scheme (MCS), in accordance with an adjusted CQI,
wherein the adjusted CQI is calculated based on:
a determination of an indication of radio conditions at a second time, the second time later than the first time, and
an evaluation of the indication of radio conditions at the second time against the indication of radio conditions contributing to the received CQI.

2. The base station of claim 1, wherein the second time is a time of scheduling.

3. The base station of claim 1, wherein the second time is a time at which the scheduled actions or instructions are scheduled to occur.

4. The base station of claim 1, wherein the processor configured to determine an indication of radio conditions at a first time contributing to the received CQI comprises the processor being configure to identify a transmission state of neighboring cells in the cellular telecommunications network.

5. The base station of claim 1, further comprising a memory configured to store a CQI associated with each transmission state of neighboring cells of the cellular telecommunications network.

6. The base station of claim 5, wherein the memory further stores a history to maintain historical information regarding the transmission state of neighboring cells of the cellular telecommunications network at particular time intervals.

7. The base station of claim 6, wherein the adjusted CQI is an average CQI, the average CQI reflecting a proportional occurrence of each transmission state in the historical information and calculated based on the stored CQI associated with each transmission state.

8. The base station of claim 5, wherein the memory is further configured to update the stored CQI associated with each transmission state when the transmission state occurred over an entire period for which the CQI was calculated.

9. The base station of claim 1, wherein the processor is further configured to:
request that the CQI be calculated and transmitted by the UE;
cause a particular behavior to occur in neighboring cells while the UE is calculating the CQI; and
store the CQI in association with the caused behavior.

10. The base station of claim 1, wherein the processor configured to determine an indication of radio conditions at a first time contributing to the received CQI comprises being configured to receive a reference signal from each neighboring cell indicative of downlink path loss at the UE.

11. The base station of claim 10, wherein the received reference signal is weighted according to a power transmitted by the neighboring cell from which the reference signal originates.

12. The base station of claim 11, wherein the processor configured to determine an indication of radio conditions at a first time contributing to the received CQI comprises the processor being configured to average the received CQI and the received reference signals.

13. The base station of claim 12, wherein the processor is further configured to:
maintain a running average of CQI values for each weighted received reference signal and for each part of a frequency band irrespective of the UE from which the CQI values were obtained.

14. The base station of claim 10, wherein the processor is further configured to:
compute a reference signal, indicative of downlink path loss at the UE, that will apply for the UE at the second time;
determine a first expected CQI corresponding to the stored CQI associated with the computed reference signal in the store;
determine a second expected CQI corresponding to the stored CQI associated with the received reference signal in the store;
calculate the difference between the first and second expected CQIs to form an adjustment parameter; and,
apply the adjustment parameter to the received CQI to form the adjusted CQI.

15. A method in a cellular telecommunications network, the method comprising:
receiving a channel quality indicator (CQI) from a user equipment (UE);
determining an indication of radio conditions at a first time contributing to the received CQI; and
scheduling actions or instructions and selecting a modulation and coding scheme (MCS), in accordance with an adjusted CQI,
wherein the adjusted CQI is calculated by:
determining an indication of radio conditions at a second time, the second time being later than the first time, and
evaluating the indication of radio conditions at the second time against the indication of radio conditions at the first time contributing to the received CQI.

16. The method of claim 15, wherein the second time is a time of scheduling.

17. The method of claim 15, wherein the second time is a time at which the actions or instructions are scheduled to occur.

18. The method of claim 15, wherein determining an indication of radio conditions at a first time contributing to the received CQI comprises monitoring a transmission state of neighboring cells of the cellular telecommunications network.

19. The method of claim 15, further comprising storing an CQI associated with each transmission state of neighboring cells of the cellular telecommunications network.

20. The method of claim 15, further comprising maintaining historical information regarding a transmission state of neighboring cells of the cellular telecommunications network at particular time intervals.

21. The method of claim 20, wherein the adjusted CQI is an average CQI, the average CQI reflecting a proportional occurrence of each transmission state in the historical information, calculated using the stored CQI associated with each transmission state.

22. The method of claim 15, further comprising updating the stored CQI associated with each transmission state, only if a transmission state occurred over an entire period for which the CQI was calculated.

23. The method of claim 15, further comprising:
requesting that the CQI be calculated and transmitted by the UE;
causing a behavior to occur in neighboring cells while the UE is calculating the CQI; and
storing the CQI in association with the caused behavior.

24. The method according claim 15, wherein determining an indication of radio conditions contributing to the received CQI comprises receiving a reference signal from each neighboring cell indicative of downlink path loss at the UE.

25. The method of claim 24, wherein the received reference signal is weighted according to a power transmitted by the neighboring cell from which the reference signal originates.

26. The method of claim 25, wherein determining an indication of radio conditions contributing to the received CQI further comprises averaging the received CQI and the received reference signals.

27. The method of claim 26, further comprising:
maintaining a running average of CQI values for each weighted received reference signal and for each part of a frequency band irrespective of the UE from which the CQI values were obtained.

28. The method of claim 24, wherein evaluating the indication of radio conditions comprises:
computing a reference signal, indicative of downlink path loss at the UE, that will apply for the UE at the second time;
determining a first expected CQI corresponding to the stored CQI associated with the computed reference signal in the store;
determining a second expected CQI corresponding to the stored CQI associated with the received reference signal in the store;
calculating the difference between the first and second expected CQIs to form an adjustment parameter; and
applying the adjustment parameter to the received CQI to form the adjusted CQI.

29. A computer program product comprising a computer readable medium encoded thereon with instructions that when executed cause a base station of a cellular telecommunications network to:
receive a channel quality indicator (CQI) from a user equipment (UE);
determine an indication of radio conditions at a first time contributing to the received CQI; and
schedule actions or instructions and selecting a modulation and coding scheme (MCS), in accordance with an adjusted CQI,
wherein the adjusted CQI is calculated by:
determining an indication of radio conditions at a second time, the second time being later than the first time, and
evaluating the indication of radio conditions at the second time against the indication of radio conditions at the first time contributing to the received CQI.
